(19) United States
(12) Patent Application Publication
(10) Pub. No.: US 2009/0118653 A1
(43) Pub. Date: May 7, 2009

(54) WEIGHTED BACK SCRATCHER

(76) Inventor: ROBERT McCOSKER, Laguna Niguel, CA (US)

Correspondence Address: AVERILL & VARN, 8244 PAINTER AVE., WHITTIER, CA, 90602, US

(21) Appl. No.: 11/933,621

(22) Filed: Nov. 1, 2007

(51) Int. Cl. A61H 7/00

(52) U.S. Cl. 601/137

(57) ABSTRACT

A back scratcher includes a set of improved full width scratching elements and moderate weight handles to allow easy grasping behind the user's back. The scratcher elements are preferably made up of four scratcher elements spaced apart along a belt and extending the width of the belt. Each scratcher element has a coarse side and a fine side. The coarse side preferably includes five pairs of fingers slightly angled apart from each other. The fine side preferably includes five triples of three angled apart fingers and four pairs of angles apart fingers spaced between the triples. The fingers on the fine side are preferably shorter than the fingers on the coarse side. Moderate weight handles are attached to each end of belt to facilitate grasping an end of the belt dropped behind a user's back.

### BACKGROUND OF THE INVENTION

The present invention relates to therapeutic devices and in particular to two handed back scratchers.

Individuals are often faced with annoying itches which are difficult or impossible to reach. Various devices are employed when forced to deal with such itches unassisted. Such devices are often a strap or the like with handles at both ends and with scratcher elements spaced along a center portion of the strap.

Unfortunately, known back scratchers fail to provide a satisfactory result because the scratcher elements are not satisfactorily pulled against the user's back and fail to impinge a swath of the back providing the desired contact with the back. Known back scratchers also are one sided. Unfortunately, the single coarseness of the one sided back scratchers is not generally satisfactory for all conditions, such as a bare back versus a user wearing a shirt.

Further, back scratchers are generally used by holding one end while dropping the opposite end behind the back. Known back scratchers have light weights handles and the opposite end may fall limply against the back and make grasping difficult.

### BRIEF SUMMARY OF THE INVENTION

The present invention addresses the above and other needs by providing a back scratcher which includes a set of improved full width scratching elements and moderate weight handles to allow easy grasping behind the user's back. The scratcher elements are preferably made up of four scratcher elements spaced apart along a belt and extending the width of the belt. Each scratcher element has a coarse side and a fine side. The coarse side preferably includes five pairs of fingers slightly angled apart from each other. The fine side preferably includes five triples of three angled apart fingers and four pairs of angled apart fingers spaced between the triples. The fingers on the fine side are preferably shorter than the fingers on the coarse side. Moderate weight handles are attached to each end of belt to facilitate grasping an end of the belt dropped behind a user's back.

In accordance with one aspect of the invention, there is provided a back scratcher including a belt, moderate weight handles attached to opposite ends of the belt, and between three and five longitudinally spaced apart scratcher elements residing near the center of the belt. The belt has a belt length of approximately 36 inches and a belt width of approximately three and one half inches.

Between three and five longitudinally spaced apart scratcher elements reside near the center of the belt. Each scratcher element includes a coarse side, a fine side, and a body having a body length of between three inches and five inches and a body width between one inch and one and one half inches. A set of between four and six pairs of spaced apart long fingers reside on the coarse side of each scratcher element and extend approximately ⅜ inches from the body. The pairs of long fingers are spaced apart along the body length and the two long fingers of each pair of long fingers are spaced apart along the body width. A set of spaced apart short fingers reside on the fine side and include between four and six triples of short fingers and one less pair of short fingers than the number of triples of short fingers residing between the triples of short fingers. The triples of short fingers are spaced apart along the body length and the three short fingers of each triple of short fingers spaced apart along the body width. The pairs of short fingers are spaced apart along the body length and the two long fingers of each pair of short fingers are spaced apart along the body width. The short fingers extend approximately ¼ inches from the fine side of each scratcher element.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1A is a top view of a back scratcher according to the present invention showing a fine side of scratcher elements.

FIG. 1B is a bottom view of the back scratcher according to the present invention showing a coarse side of scratcher elements.

FIG. 1C is an edge view of the back scratcher according to the present invention showing the edge of both the fine and coarse sides of scratcher elements.

FIG. 2A is a detailed view of the fine side of the scratcher element.

FIG. 2B is a detailed view of the coarse side of the scratcher element.

FIG. 2C is a detailed edge of both the fine and coarse sides of scratcher elements.

FIG. 3 shows the attachment of a medium weight handle to a belt of the back scratcher according to the present invention.

FIG. 4A is a top view of the medium weight handle.

FIG. 4B is an edge view of the medium weight handle.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

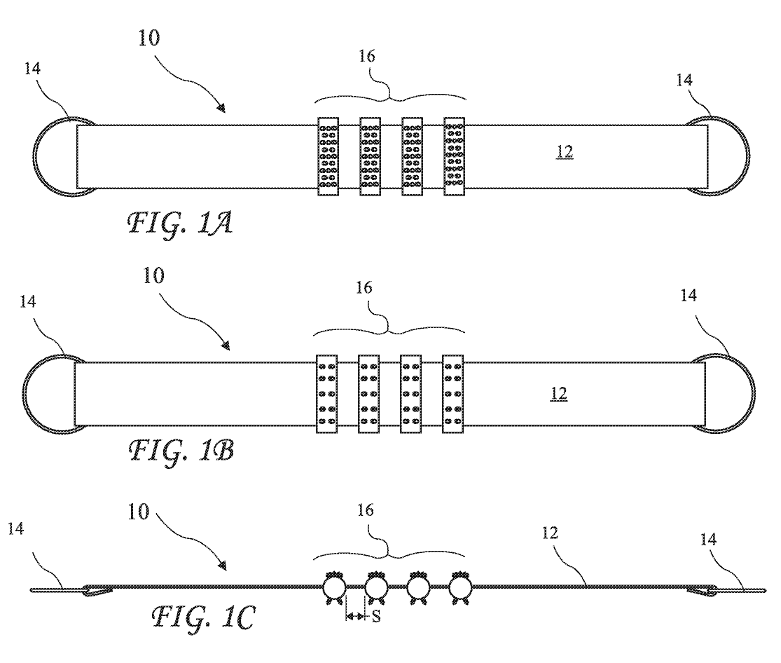

A top view of a back scratcher 10 according to the present invention showing a fine side of scratcher elements 16 is shown in FIG. 1A, a bottom view of the back scratcher 10 showing a coarse side of the scratcher elements 16 is shown in FIG. 1B, and an edge view of the back scratcher 10 showing the edge of both the fine and coarse sides of scratcher elements 16 is shown in FIG. 1C. The back scratcher 10 includes a flexible belt 12 with handles 14 attached to each end of the belt. The handles 14 are medium weight handles weighing between approximately four and approximately six ounces. The back scratcher 10 preferably includes three to six scratcher elements 16 and more preferably four scratcher elements 16 residing spaced apart near the center of the belt 12. The scratcher elements 16 are preferably spaced apart by spacing S between approximately one inch and approximately 1½ inches and is more preferably approximately 1¼ inches.

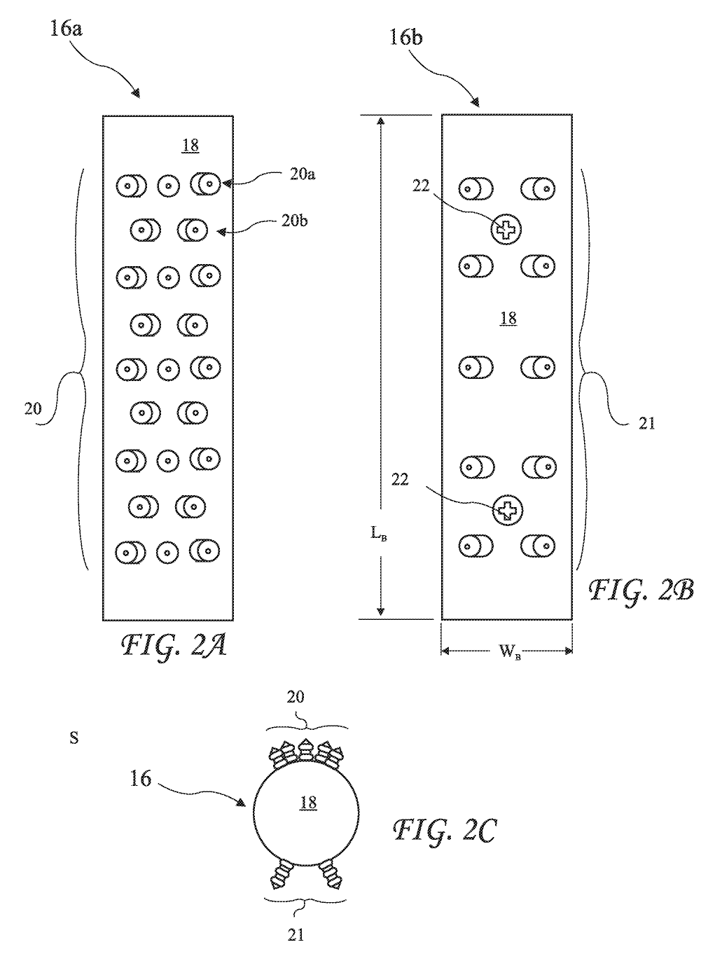

A detailed view of the fine side 16a of the scratcher element 16 is shown in FIG. 2A, a detailed view of the coarse side 16b of the scratcher element 16 is shown in FIG. 2B, and a detailed edge view of both the fine and coarse sides of the scratcher element 16 is shown in FIG. 2C. Each scratcher element 16 has a cylindrical body 18 having a body length L_{B} and a body width W_{B} (or diameter). The body length L_{B} is preferably between three inches and five inches and is more preferably approximately four inches. The body width W_{B} is preferably between one inch and 1½ inches and is more preferably approximately 1¼ inches. The body 18 is preferably round, but may be oval, elliptical, or generally rounded in cross-section.

The fine side 16a of the scratcher element 16 is populated with short fingers 20 extending approximately ¼ inches from the body 18 of the scratcher element 16. The short fingers 20 are preferably arranged in spaced apart triples 20a and in spaced apart pairs 20b, the triples and pairs spaced apart along the body length L_{B}. Each triple 20a of short fingers 20 includes three short fingers 20 spaced apart along the body width W_{B} and each pair 20b of two short fingers 20 includes two of short fingers 20 spaced apart along the body width W_{B}. The fine side 16a preferably includes between four and six triples 20a of short fingers 20 and between three and six pairs 20b of short fingers 20. More preferably, the fine side 16a includes one less pair 20b of short fingers 20 than the number of triples 20a of short fingers 20, with the pairs 20b of short fingers 20 spaced apart between the triples 20a of short fingers 20 along the body length L_{B}. Most preferably, the fine side 16a includes four pairs 20b of short fingers 20 and five triples 20a of short fingers 20, with the pairs 20b of short fingers 20 spaced apart between the triples 20a of short fingers 20 along the body length L_{B}. In other embodiments, the short fingers 20 may be spaced apart in various arrangements or be spaced randomly, and any scratcher having a fine side with between eighteen and twenty eight spaced apart short fingers 20 in any arrangement is intended to come within the scope of the present invention.

The coarse side 16b of the scratcher element 16 is populated with long fingers 21 extending approximately ⅜ inches from the body 18 of the scratcher element 16. The long fingers 21 are preferably arranged as pairs, with the two long fingers 21 of each pair spaced apart along the body width W_{B}, and the pairs spaced apart along the body length L_{B}. Preferably, between four and six pairs of long fingers 21 are spaced apart along the body length L_{B}, and more preferably, five pairs of long fingers 21 are spaced apart along the body length L_{B}. In other embodiments, the long fingers 21 may be spaced apart in various arrangements or be spaced randomly, and any scratcher having a course side with between eight and fifteen spaced apart long fingers 21 in any arrangement is intended to come within the scope of the present invention.

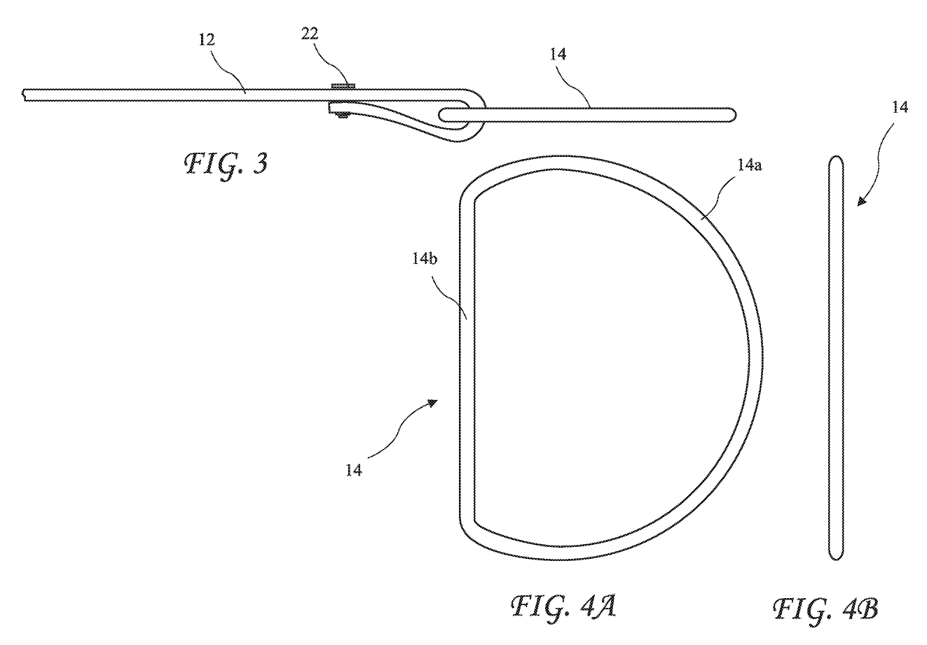

The attachment of the medium weight handle 14 to the belt 12 of the back scratcher 10 is shown in FIG. 3. The material forming the belt 12 is looped through the handle 14 and attached to the belt 12. The attachment may be made using two or more fasteners, for example, rivets, screws, or the like, or may be by sewing.

A top view of the medium weight handle 14 is shown in FIG. 4A and an edge view of the medium weight handle 14 is shown in FIG. 4B. The handle is preferably “D” shaped with a loop portion 14a exposed for grasping and a straight portion 14b held by the belt 12. Other handles may be used but are preferably medium weight to cause the belt to drop when held behind a user's back and not to catch on the user's back.

While the invention herein disclosed has been described by means of specific embodiments and applications thereof, numerous modifications and variations could be made thereto by those skilled in the art without departing from the scope of the invention set forth in the claims.

I claim:

1. A back scratcher comprising:
a belt having a belt length between twenty inches and forty inches and a belt width between two inches and four and one half inches;
moderate weight handles attached to opposite ends of the belt;
a plurality of longitudinally spaced apart scratcher elements attached near the center of the belt, the scratcher elements having a coarse side and a fine side;
a set of coarse spaced apart fingers on the coarse side; and
a set of fine spaced apart fingers on the fine side.

2. The back scratcher of claim 1, wherein the belt length is approximately 36 inches.

3. The back scratcher of claim 1, wherein the belt width is approximately three and one half inches.

4. The back scratcher of claim 1, wherein the plurality of longitudinally spaced apart scratcher elements comprises between three and five longitudinally spaced apart scratcher elements.

5. The back scratcher of claim 4, wherein the scratcher elements comprise scratcher element bodies running across the belt with a body width of between one inch and one and one half inches.

6. The back scratcher of claim 5, wherein the scratcher elements comprise scratcher element bodies running across the belt width with a body width of approximately one and one quarter inches and a body length of between three inches and five inches.

7. The back scratcher of claim 5, wherein the scratcher elements have a round cross-section.

8. The back scratcher of claim 5, wherein the body length is approximately one half inch greater than the belt width.

9. The back scratcher of claim 5, wherein the belt passes through the scratcher elements.

10. The back scratcher of claim 5, wherein the coarse spaced apart fingers comprise a plurality of pairs of long fingers, the pairs of long fingers spaced apart along the body length, the two long fingers of each pair of long fingers spaced apart along the body width.

11. The back scratcher of claim 10, wherein the pairs of long fingers comprise between four and six pairs of long fingers, the pairs of long fingers spaced apart along the body length of each scratcher element.

12. The back scratcher of claim 11, wherein the coarse spaced apart pairs of long fingers comprise five pairs of coarse spaced apart long fingers.

13. The back scratcher of claim 12, wherein the coarse spaced apart pairs of long fingers comprise the long fingers having a long finger length of approximately ⅜ inches.

14. The back scratcher of claim 5, wherein the fine spaced apart fingers comprise between 18 and 28 spaced apart short fingers residing on the fine side of each scratcher element.

15. The back scratcher of claim 14, wherein the spaced apart short fingers comprise:
a multiplicity of triples of short fingers, the triples spaced apart along the body length, the three short fingers of each triple of short fingers spaced apart along the body width, and
a multiplicity of pairs of short fingers, the pairs of short fingers spaced apart along the body length, the two short fingers of each pair of short fingers spaced apart along the body width, and the pairs of short fingers spaced between the triples of short fingers.

16. The back scratcher of claim 15, wherein:
the triples of short fingers comprise between four and six triples of short fingers; and
the pairs of short fingers comprise one less pair of pairs of short fingers than the number of triples of short fingers.

17. The back scratcher of claim 16, wherein the short fingers have a short finger length of approximately ¼ inches.

18. The back scratcher of claim 1, wherein the handles weigh between approximately four and approximately six ounces.

19. A back scratcher comprising:
a belt having a belt length of approximately 36 inches and a belt width of approximately three and one half inches;
moderate weight handles attached to opposite ends of the belt;
between three and five longitudinally spaced apart scratcher elements residing near the center of the belt, the scratcher elements having;
a coarse side;
a fine side; and
a body having a body length of between three inches and five inches and a body width between one inch and one and one half inches;
a set of between four and six pairs of spaced apart long fingers residing on the coarse side of each scratcher element and extending approximately ⅜ inches from the body, the pairs of long fingers spaced apart along the body length, the two long fingers of each pair of long fingers spaced apart along the body width; and
a set of spaced apart short fingers on the fine side comprising:
between four and six triples of short fingers, the triples of short fingers spaced apart along the body length, the three short fingers of each triple of short fingers spaced apart along the body width, and
one less pair of short fingers than the number of triples of short fingers, the pairs of short fingers spaced apart along the body length, the two short fingers of each pair of short fingers spaced apart along the body width, and the pairs of short fingers spaced between the triples of short fingers, the short fingers extending approximately ¼ inches from the fine side of each scratcher element.

20. A back scratcher comprising:
a belt having a belt length of approximately 36 inches and a belt width of approximately three and one half inches;
moderate weight handles attached to opposite ends of the belt;
four longitudinally spaced apart scratcher elements residing near the center of the belt, the scratcher elements having;
a coarse side;
a fine side; and
a body having a body length of between three inches and five inches and a body width between one inch and one and one half inches;
a set of five pairs of spaced apart long fingers residing on the coarse side of each scratcher element and extending approximately ⅜ inches from the body, the pairs of long fingers spaced apart along the body length, the two long fingers of each pair of long fingers spaced apart along the body width; and
a set of spaced apart short fingers on the fine side comprising:
five triples of short fingers, the triples of short fingers spaced apart along the body length, the three short fingers of each triple of short fingers spaced apart along the body width, and
four pairs of short fingers spaced apart along the body length, the two short fingers of each pair of short fingers spaced apart along the body width, and the pairs of short fingers spaced between the triples of short fingers, the short fingers extending approximately ¼ inches from the fine side of each scratcher element.
